(19) United States
(12) Patent Application Publication
(10) Pub. No.: US 2014/0273980 A1
(43) Pub. Date: Sep. 18, 2014

(54) VOICEMAIL MIGRATION

(71) Applicant: CELLCO PARTNERSHIP D/B/A VERIZON WIRELESS, Basking Ridge, NJ (US)

(72) Inventors: Rodney Dale REGAN, Somerville, NJ (US); Hugo D. MUNOZ SANCHEZ, Morristown, NJ (US); Henry H. LI, Madison, NJ (US)

(73) Assignee: CELLCO PARTNERSHIP D/B/A VERIZON WIRELESS, Basking Ridge, NJ (US)

(21) Appl. No.: 13/843,221

(22) Filed: Mar. 15, 2013

(51) Int. Cl. H04W 4/12; H04W 8/20

(52) U.S. Cl. CPC H04W 4/12; H04W 8/20
USPC 455/413

(57) ABSTRACT

A subscriber's voicemail information is migrated from one voicemail system to another voicemail system. A telephone service activation server can send an instruction to a destination voicemail system to create a new voicemail account for the subscriber and a migration instruction to a migration server. The migration server can obtain voicemail information in the existing voicemail account from a source voicemail system and transmit the obtained voicemail information to the destination voicemail system where it can be stored in the subscriber's new voicemail account.

### BACKGROUND

Subscribers of mobile communication networks or other communication networks are often provided with voicemail services. These voicemail services may be provided by different vendors and/or are implemented on different voicemail systems. A subscriber's voicemail service may change from one system to another for various reasons. For example, a subscriber can change from one voicemail system to another because they changed their number, they switched to a different mobile device, they upgraded their voicemail service, or they move to a different geographic area. Typically, when a subscriber moves from one voicemail system to a different voicemail system, due to incompatibilities between the different systems the voicemail messages on the old system as well as voicemail profile information (e.g., settings, configurations, greeting messages, recorded name, etc.) are lost. In some cases, a subscriber may be able to access certain information from the old voicemail system; however, that information cannot be transferred to the new voicemail system. For example, to the extent that the user may want similar settings on the new voicemail system, the user may be forced to manually re-enter the setting information into the new system.

Hence while a need exists for migrating voicemail information between incompatible voicemail systems, the different voicemail systems may use different technologies and protocols, some or all of which may be proprietary. Accordingly, coordinating between voicemail systems may be difficult.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 is a high-level functional block diagram of an example of a network environment that may be involved in a subscriber transitioning from one voicemail system to another.

FIG. 2 is a high-level functional block diagram of an example of a network environment that may be involved in migrating a subscriber's voicemail information from one voicemail system to another.

FIG. 3 is a high-level functional block diagram of another example of a network environment that may be involved in migrating a subscriber's voicemail information from one voicemail system to another.

FIG. 4 is a high-level functional block diagram of another example of a network environment that may be involved in migrating a subscriber's voicemail information from one voicemail system to another.

FIG. 5 is a data flow diagram that illustrates an example of a migration of a subscriber's voicemail information from one voicemail system to another.

FIG. 6A is a flow diagram illustrating an example of a process for obtaining a subscriber's voicemail information from a source voicemail system.

FIG. 6B is a flow diagram illustrating an example of a process for transmitting a subscriber's voicemail information to a destination voicemail system.

FIG. 7 is a flow diagram illustrating another example of a process for migrating a subscriber's voicemail information from a source voicemail system to a destination voicemail system.

FIG. 8 is a flow diagram illustrating an example of a process for migrating a subscriber's voicemail information to a new voicemail account on a voicemail system.

FIGS. 9A and 9B are flow diagrams illustrating another example of a process for migrating a subscriber's voicemail information to a new voicemail account on a voicemail system.

FIG. 10 is a simplified functional block diagram of a computer that may be configured as a host or server, for example, to function as the TSAS server or the voicemail (VM) migration server in the example network environment of FIG. 2.

FIG. 11 is a simplified functional block diagram of a personal computer or other work station or terminal device.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

Various aspects of the subject technology disclosed herein relate to migrating a subscriber's voicemail information (voicemail messages and/or profile information) from a voicemail account on one voicemail system to another voicemail account on another voicemail system. The subject technology may also be able to migrate a subscriber's voicemail information from a voicemail account on one voicemail system to another voicemail account on the same voicemail system. The voicemail information migrated to a new voicemail account may not include voicemail messages if, for example, there are no voicemail messages in the subscriber's old voicemail account or if the subscriber has not initialized their new voicemail account. Reference now is made in detail to the examples illustrated in the accompanying drawings and discussed below.

FIG. 1 is a high-level functional block diagram of an example of a network environment that may be involved in a subscriber transitioning from one voicemail system to another. The network environment may include two portions: a service provider portion and a vendor and voice network portion. The service provider portion provides management services for subscribers. For example, elements of the service provider portion may be configured to provision new accounts for subscribers, perform billing processes for subscribers, or perform any other operations, administration, or maintenance functionality to support subscribers. The elements in the voice network portion may be configured to handle and route subscriber phone calls or voicemail messages. Although the service provider and vendor and voice network portions are shown as separate, certain elements from one portion may also be implemented on another portion. Furthermore, a service provider, for example, may maintain and manage elements on the service provider portion or elements on the vendor and voice network portion. The vendor and voice network portion may include one or more voicemail systems, such as voicemail (VM) system 112, VM system 114, and VM system 116 in FIG. 1, provided by one or more voicemail vendors.

Each voicemail system is configured to store voicemail information for one or more subscribers and allows subscribers to exchange voice messages and access voice messages from a user device. The voicemail information for a subscriber may include a subscriber's voice messages and profile information for the subscriber's voicemail account. The profile information may include voicemail settings, preferences, subscriber information, subscriber passwords used to access the voicemail account, or recorded audio for the voicemail account (e.g., a recorded greeting or a recorded subscriber name).

In one example scenario, a caller may call a telephone number associated with a subscriber and be directed to a voicemail system for the subscriber. The caller may be directed to the voicemail system for the subscriber, for example, if the subscriber is unavailable. Once the caller is directed to the voicemail system, the caller may hear a voicemail greeting for the subscriber or the subscriber's recorded name indicating that the caller may record an audio message for the subscriber. The greeting or name would be part of the profile information for the subscriber's voicemail account stored on the particular voicemail system. The voicemail system may record an audio message from the caller and store the recorded audio message in the subscriber's voicemail account. Over time, the voicemail system may receive and store a number of such recorded audio messages in the subscriber's voicemail account, which the subscriber may want to transfer as part of a migration, e.g. to another voicemail system. The subscriber may access (e.g., retrieve) the recorded audio message from the caller at a later time by interfacing with the voicemail system, typically, upon successful entry of a password, which is another part of the profile information for the subscriber's voicemail account stored on the particular voicemail system.

Each voicemail system may be operated by different vendors and thus support different voicemail features, different mobile devices, or be implemented in different ways. For example, some voicemail systems may encode and decode certain audio information (e.g., voicemail messages, greetings, recorded name, or other recorded audio data) using a particular codec while another voicemail system may encode and decode the audio information using a different codec. Different codecs utilize different encoding and decoding algorithms. In some cases, the voicemail systems may use codecs that are proprietary or codecs that are not published and/or kept secret. Accordingly, using different codecs may allow voicemail systems to store audio information but prevent other entities from accessing that information on the voicemail system. It therefore may be very difficult to access audio information without knowing the codec used to encode audio information. In other cases, voicemail systems may prevent other entities from accessing audio information or other voicemail information (e.g., voicemail profile information) by encrypting the voicemail information using an encryption algorithm. In this later case, it may be very difficult to access audio information without knowing the encryption algorithm used to encode audio information. Direct interaction between the different voicemail systems, and thus direct transfer of voicemail and voicemail settings between these systems, is at best very difficult. This forces the service provider to intervene in a herein-described complex and time-intensive interaction between the various systems to reestablish a subscriber's voicemail box.

Certain mobile devices and voicemail systems also allow for visual voicemail (VVM) features. Visual voicemail features may enable a subscriber's voicemail account or portions of the voicemail account (e.g., voicemail messages) stored on a voicemail system to be transmitted to a subscriber's mobile device where it can be accessed by the subscriber. Visual voicemail features may also enable a visual interface to be displayed on a subscriber's mobile device and allow the subscriber to access voicemail messages, delete voicemail messages, or otherwise make changes to the subscriber voicemail account stored locally on the subscriber's mobile device. Any changes (e.g., deleted voicemail messages or changing the status of voicemail messages from an unread status to a read status) on the local voicemail account may be transmitted back to the voicemail account stored on the voicemail system, where they may be applied.

A visual voicemail (VVM) gateway 120 may support the VVM features on the mobile devices by managing the communications between the mobile devices and the voicemail systems needed to provide the VVM features. For example, a visual voicemail (VVM) gateway 120 may be configured to retrieve voicemail messages for a subscriber's voicemail account through the vendor gateway (e.g., vendor gateways 122 and 124) for the voicemail system that the subscriber's voicemail account is on. For example, if a subscriber has a voicemail account on VM system 116 in FIG. 1, the VVM gateway may contact vendor gateway 124 and retrieve the subscriber's voicemail messages. The vendor gateway 120 is a system that is configured to provide an interface for one or more voicemail systems. For example, if voicemail information stored on a voicemail system is encoded using a particular codec or encrypted, the vendor gateway 120 may be configured to receive requests for the voicemail information, decode or decrypt the requested information, and provided the requested information to the requester. After retrieving the voicemail messages from the subscriber's voicemail account, the VVM gateway may transmit the voicemail messages to the subscriber's mobile device where it can be stored and/or accessed locally by the subscriber.

The service provider portion of the network environment may include telephone service activation system (TSAS) server 110 configured to activate subscriber accounts, including voicemail accounts, by communicating with network elements and provisioning the resources needed to activate a subscriber account. For example, a voicemail account may be activated for a new subscriber or if a subscriber is transitioning voicemail systems for some reason (e.g., the subscriber changed their number, switched to a different mobile device supported by a different voicemail system, changed voicemail service, or moved to a geographic area supported by a different voicemail system). To create a voicemail account for a subscriber, the TSAS server 110 may contact the voicemail system, such as VM system 112, VM system 114, and VM system 116 in FIG. 1, where the new voicemail account is to reside and instruct the new voicemail system to create the new voicemail account for the subscriber.

If a subscriber is transitioning from using one voicemail system to using another (e.g., VM System 112 to VM System 114 in FIG. 1), the TSAS server 110 may contact the new voicemail system the subscriber is changing to and instruct the new voicemail system to create a new voicemail account for the subscriber. The TSAS server 110 may also contact the old voicemail system where the subscriber is changing from and instruct the old voicemail system to delete the subscriber's old voicemail account. Once the voicemail account on the old system is deleted, the voicemail messages and other information in the old voicemail account are no longer accessible to the subscriber.

In some cases, the TSAS server 110 may delay instructing the old voicemail system to delete the subscriber's old voicemail account so that information (e.g., old voicemail messages) in the old voicemail account may still be accessible to the subscriber for a period of time, 30 days for example. For example, the subscriber may be provided with a phone number that may be dialed to reach an interface for the old voicemail account. After the subscriber is identified and authenticated, for example by providing the subscriber's phone number and voicemail PIN number, the subscriber is able to use the interface to listen to voicemail messages on the old voicemail account. However, once the delay period expires, the voicemail account on the old voicemail system is deleted and the subscriber is unable to access the information in the old voicemail account.

Some subscribers, however, may wish to continue to have access to information (e.g., old voicemail messages) stored on the old voicemail account. Furthermore, it may be more convenient for subscribers to be able to access the information in the old voicemail account using the same interface as their new voicemail account. Accordingly, a need exists for migrating voicemail information from an old voicemail account on one voicemail system to a new voicemail account on another voicemail system. However, the different voicemail systems may use different technologies or protocols and may implement measures to prevent other entities from accessing voicemail information. For example, as described above, certain information stored by voicemail systems may be encoded using a codec that prevents access to the voicemail information.

FIG. 2 is a high-level functional block diagram of an example of a network environment that may be involved in migrating a subscriber's voicemail information from one voicemail system to another. The network environment may include one or more voicemail systems, such as VM system 212, VM system 214, and VM system 216, provided by one or more voicemail vendors. As described above with respect to FIG. 1, each voicemail system may support different voicemail features, different mobile devices, or be implemented in different ways. Furthermore, certain mobile devices and voicemail systems also allow for visual voicemail (VVM) features supported by a visual voicemail (VVM) gateway (not shown in FIG. 2).

The network environment in FIG. 2 may also include a service provider portion that has a telephone service activation system (TSAS) server 210 and a voicemail (VM) migration server 220. The TSAS 210 is configured to activate subscriber accounts, including voicemail accounts, by communicating with network elements and provisioning the resources needed to activate a subscriber account. For example, a voicemail account may be activated for a new subscriber or if a subscriber is transitioning voicemail systems. Similarly to TSAS server 110, the TSAS server 210 may activate a voicemail account for a subscriber by contacting the voicemail system that the voicemail account is to be located on (e.g., such as VM system 212) and instruct the new voicemail system to create the new voicemail account for the subscriber.

The TSAS server 210 may also be configured to migrate information (e.g., voicemail messages, profile information, etc.) in a subscriber's old voicemail account in one voicemail system to a new voicemail account in a different voicemail system. Accordingly, the subscriber will not lose access to voicemail information that was previously stored in the old voicemail account. Instead, the subscriber will be able to access the old voicemail information in the new voicemail account on the new voicemail system. The TSAS server 210 can migrate voicemail information from an existing voicemail account on a source voicemail system (e.g., the old voicemail system) to a new voicemail account on a destination voicemail system (e.g., the new voicemail system) by sending an instruction to a computer of the destination voicemail system, such as vendor gateway 224 or VM system 216 in FIG. 2, to create a new voicemail account for the subscriber. In some variations, the vendor gateway 224 or other vendor gateways may be implemented as a message application broker (MAB). In response to receiving the instruction, the VM system 216 will create the new voicemail account for the subscriber so that voicemail information from the source voicemail account may be transferred into the new voicemail account (e.g., the destination account).

The TSAS server 210 also sends a migration instruction to the VM migration server 220. The migration instruction may specify, for example, the source voicemail system, the destination voicemail system, an identifier of the existing voicemail account, and an identifier for the new voicemail account. When the VM migration server 220 receives the migration instructions from the TSAS server 210, the VM migration server 220 may obtain voicemail information in the existing voicemail account from one or more computers of the source voicemail system, such as VM system 212 and/or vendor gateway 222. The voicemail information may include profile information for the subscriber's existing voicemail account and one or more voicemail messages stored in the existing voicemail account. The profile information may include voicemail settings, preferences, subscriber information, subscriber passwords used to access the voicemail account, recorded audio for the voicemail account (e.g., a recorded greeting or a recorded subscriber name).

After the voicemail information is obtained, the VM migration server 220 transmits the obtained information to the computer of the destination voicemail system (e.g., VM system 216 in FIG. 2) where it can be stored in the subscriber's new voicemail account. When the voicemail information is received at the destination voicemail system, the profile information may be used to configure the new voicemail account for the subscriber. For example, the voicemail settings and the preferences from the old voicemail account may be used to set the voicemail settings and preferences for the new voicemail account. The subscriber information from the old voicemail account may be used to update subscriber information in the new voicemail account. Furthermore, the recorded greeting or subscriber name may be used as the recorded greeting or subscriber name in the new voicemail account. The voicemail messages may also be stored in the destination voicemail system and associated with the new voicemail account for the subscriber.

FIG. 3 is another high-level functional block diagram of an example network environment that may be involved in migrating a subscriber's voicemail information from one voicemail system to another. The example network environment in FIG. 3 includes many of the same elements as the network environment in FIG. 2 and shows communication channels that may be used in migrating a subscriber's voicemail information from one voicemail system to another.

As described above, the TSAS server 210 can send instructions to a computer of the destination voicemail system (e.g., vendor gateway 224 or VM system 216 in FIG. 2) to create a new voicemail account for the subscriber, which causes the computer of the destination voicemail system to provision resources for a new voicemail account. The TSAS server 210 also sends migration instructions to the VM migration server 220. The instructions sent from the TSAS server 210 to the computer of the destination voicemail system or the VM migration server 220 may be in accordance with any number of communication protocols. In some cases, an Application Programming Interface (API), such as a specific provisioning interface, may be used.

The VM migration server 220 also may be configured to communicate with one or more computers of voicemail systems. More specifically, the VM migration server 220 is able to communicate directly with one or more vendor gateways (e.g., vendor gateway 222 or 224), with one or more VM systems (e.g., voicemail system 212, 214, 216, or 318), or with a combination of vendor gateways and VM systems. The VM migration server 220 may also communicate with the vendor gateways or the VM systems by any number of methods or a combination of methods. For example in FIG. 3, the VM migration server 220 may communicate with vendor gateway 222 using a hypertext transfer protocol secure (HTTPS) communication protocol and communicate with vendor gateway 224 using an internet message access protocol (IMAP). The VM migration server 220 may also communicate with, for example VM systems 216 and 318 using a lightweight directory access protocol (LDAP).

The vendor gateways may also communicate with and support one or more voicemail systems using one or more methods. For example, in FIG. 3, vendor gateway 224 may communicate with VM system 216 and VM system 318 using a combination of the IMAP and the simple mail transfer protocol (SMTP). Other protocols may also be used. The voicemail systems of the same vendor may also be configured to communicate with one another. For example, in FIG. 3, VM system 212 and VM system 214 may be configured to communicate with one another.

FIG. 4 is another high-level functional block diagram of an example network environment that may be involved in migrating a subscriber's voicemail information from one voicemail system to another. The network environment may include more than one VM migration server. In some cases, the VM migration server may be implemented using a cluster of computing machines. For example, in FIG. 4, the network environment includes VM migration servers 420, 422, and 424 and the TSAS server 410 may be configured to transmit migration instructions to one or more of the VM migration servers 420, 422, and 424. Similarly, each voicemail system may be supported by one or more vendor gateways and each vendor gateway may support one or more voicemail systems. For example, voicemail systems 416 and 418 may each be supported by vendor gateways 434 and 436. Vendor gateways 434 and 436 may each also support voicemail systems 416 and 418.

FIG. 5 is an example data flow diagram that illustrates the migration of a subscriber's voicemail information from one voicemail system to another. FIG. 5 shows one possible configuration of communication channels; however, other configurations may also be used. In FIG. 5, the telephone service activation system (TSAS) server 510 and the voicemail migration server 520 are configured to migrate a subscriber's voicemail information from a source voicemail system to a destination voicemail system. For example, one voicemail system (e.g., VM system 532, which may be implemented using one or more computing machines) may be developed and/or managed by one vendor (e.g., via vendor gateway 530) while one or more other voicemail systems (e.g., VM systems 542, 544, and 546) may be developed and/or managed by another vendor (e.g., via vendor gateways 540). Furthermore, the TSAS server 510 and the voicemail migration server 520 may be developed and/or managed by another party (e.g., the service provider).

To migrate a subscriber's voicemail information from VM system 532 to VM system 542, the TSAS server 510 may transmit instructions to create a new voicemail account to VM system 542. In response to receiving the instructions, the VM system 542 may attempt to create a voicemail account for the subscriber and, if successful, transmit an indication that the attempt was successful. In one variation, the TSAS server 510 may also transmit migration instructions to the voicemail migration server 520 and obtain voicemail profile information from VM system 532. Voicemail profile information may include, for example, subscriber information, voicemail account features, settings, preferences, voicemail greetings, or a recorded name.

The voicemail migration server 520 may also be configured to communicate with the vendor gateway 530 and/or the VM systems 532 in order to obtain voicemail messages and/or greetings from the source voicemail account. The obtained voicemail messages and/or greetings may be transmitted to one or more of the vendor gateways 540 managing the destination voicemail system 542 to be delivered to the destination voicemail system 542 or the obtained voicemail messages and/or greetings may be transmitted directly to the destination voicemail system 542.

FIGS. 6A and 6B are flow diagrams illustrating an example of a process for migrating a subscriber's voicemail information from one voicemail system to another. In particular, FIG. 6A is a flow diagram illustrating an example of a process for obtaining a subscriber's voicemail information from a source voicemail system. FIG. 6B is a flow diagram illustrating an example of a process for transmitting a subscriber's voicemail information to a destination voicemail system. The process includes operations performed by a migration initiator 602, a telephone service activation system (TSAS) server 604, a voicemail migration server 606, voicemail system A 610, gateway A 608, which supports voicemail system A 610, voicemail system B 614, and gateway B 612, which supports voicemail system B 614. In the example process shown in FIG. 6A and FIG. 6B, voicemail information in a source voicemail account on voicemail system B 614 is migrated to a new destination voicemail account on voicemail system A 610.

The migration initiator 602 may be a system managed by a service provider that transmits instructions, at operation 620, to the TSAS 604 to initiate a voicemail account migration. The instructions may be transmitted in response to a subscriber changing voicemail services, changing phone numbers, getting a new phone supported by a different voicemail system, moving to a new geographic area supported by a different voicemail system, or for some other reason. The instructions may be in the form of a special feature offering (SFO) code which identifies additional features for the subscriber's mobile device account or voicemail account. These features may include, for example, as call forwarding, call waiting, or three party conferencing. These enhanced features can be offered to customers as individual features or as a group of features put into a package (e.g., an enhanced service package). When the TSAS 604 receives the SFO code, the TSAS 604 may look up the SFO code in a SFO code table and determine that the subscriber's voicemail account on a source voicemail system (e.g., VMS B 614) is to be migrated to another voicemail account on a destination voicemail system (e.g., VMS A 610).

In response to receiving instructions to initiate the voicemail account migration, at operation 622, the TSAS 604 sends instructions to the destination voicemail system to create the new voicemail account for the subscriber. The voicemail system (VMS) A 610 can create the new voicemail account for the subscriber in response to receiving the instructions. At operation 624, the TSAS 604 may transmit to the VMS A 610 information needed to set up the newly created voicemail account. The information may include an indication of features and/or characteristics for the newly created account.

At operation 626, the TSAS 604 sends instructions to the voicemail migration server 606 to migrate information in the subscriber's old voicemail account on the source voicemail system to the new voicemail account on the destination voicemail system (e.g., VMS A 610). However, the voicemail migration server 606 may not be aware of on which voicemail system the subscriber's existing voicemail account is located and there may be more than one voicemail system that the source voicemail account can be located on. Accordingly, in response to receiving the migration instructions, the voicemail migration server 606 may probe the voicemail gateway (e.g., gateway B 612) for the source voicemail system (e.g., VMS B 614) for information needed to access the source voicemail system at operation 628. For example, the probe may be a communication sent to gateway B 612 requesting the location (e.g., the internet protocol (IP) address) for the voicemail system (e.g., VMS B 614) on which the subscriber's existing voicemail account is located. The probe may be an IMAP communication that asks the voicemail gateway whether the gateway can locate the subscriber's voicemail account. If the voicemail gateway can locate the subscriber's voicemail account or if an initial probe does not return a usable response (e.g., if the initial gateway is unresponsive or otherwise unable to provide the location of the voicemail system), the voicemail migration server 606 may continue using the voicemail gateway to access the source voicemail system. If the voicemail gateway cannot locate the subscriber's voicemail account, other voicemail gateways that support the voicemail systems may be probed (e.g., queried). According to some variations, a voicemail gateway may support multiple voicemail systems. Additionally, a voicemail system may be supported by multiple voicemail gateways in some implementations.

The voicemail gateway B 612 may determine the location of the source voicemail system that the subscriber's existing account is on and return the location (e.g., the IP address) to the voicemail migration server 606 at operation 630. Now with the location of the source voicemail system that the subscriber's existing account is on, at operation 632, the voicemail migration server 606 may contact the voicemail system (e.g., VMS B 614) to establish a migration channel between the VM migration server 606 and the VMS B 614. According to some implementations, in order to retrieve information from the subscriber voicemail account, the VMS B 614 locks access to the subscriber voicemail account to other clients. Furthermore, the VMS B 614 will only lock the subscriber's voicemail account and allow access to the subscriber's voicemail account if the VMS B 614 is set to a particular access level (e.g., a particular class of service). Accordingly, setting up the migration channel may include sending a communication to the VMS B 614 that sets the voicemail system's access level to one that allows for the locking of the subscriber's voicemail account and for access to the information stored in the voicemail account.

After the migration channel is established, the voicemail migration server 606 may request the information in the subscriber's existing voicemail account using one or more requests. For example, at operation 634, the voicemail migration server 606 may transmit a request for voicemail account profile information to the voicemail system B 614. The profile information may include voicemail settings, preferences, subscriber information, or subscriber passwords used to access the voicemail account. In response to receiving the request for profile information, VMS B 614 may retrieve the profile information and transmit the profile information to the voicemail migration server 606 at operation 636.

In some cases the recorded audio (e.g., the voicemail greeting, the recorded name, the voicemail messages, etc.) in the subscriber's voicemail account may be stored in VMS B 614 in an encoded form to prevent unauthorized access to the recorded audio. Accordingly, gateway B 612 may be used as an intermediary between VMS B 614 and the voicemail migration server 606 and decodes the recorded audio before transmitting the recorded audio to the voicemail migration server 606. For example, at operation 638, the voicemail migration server 606 may transmit a request for a voicemail greeting to the gateway B 612 and the gateway B 612 can relay the request to the VMS B 614. In response to receiving the request, the VMS B 614 may retrieve the voicemail greeting in the subscriber's voicemail account and transmit it to the gateway B 612. Similarly, at operation 640, the voicemail migration server 606 may transmit a request for a recorded name to the gateway B 612 and the gateway B 612 can relay the request to the VMS B 614. In response to receiving the request, the VMS B 614 may retrieve the recorded name in the subscriber's voicemail account and transmit it to the gateway B 612. At operation 642, the voicemail migration server 606 may also transmit a request for one or more of the voicemail messages in the subscriber's voicemail account to the gateway B 612 and the gateway B 612 can relay the request to the VMS B 614. In response to receiving the request, the VMS B 614 may retrieve the voicemail messages in the subscriber's voicemail account and transmit it to the gateway B 612.

At the gateway B 612, the voicemail greeting, the recorded name, the voicemail messages, or other recorded audio in the subscriber's voicemail account may be decoded and, at operation 644, the decoded recorded audio can be transmitted to the voicemail migration server 606. Once all the information requested from the source voicemail system is received at the voicemail migration server 606, it can be stored in memory for later transmission to the destination voicemail system (e.g., VMS A 610). The voicemail migration server 606 may also send a communication to the VMS B 614 to close the migration channel at operation 646. If the access level for VMS B 614 was set to a particular access level when the migration channel was established, the voicemail migration server 606 may set the access level for VMS B 614 to the previous access level to return the VMS B 614 to normal operation.

Once voicemail information from the subscriber's voicemail account on the source voicemail system is received, the voicemail migration server 606 may begin transmitting the voicemail information for the subscriber's new voicemail account on the destination voicemail system. For example, at operation 652 in FIG. 6B, the voicemail migration server 606 may transmit the voicemail greeting to the gateway A 608, which in turn will deposit the voicemail greeting into the subscriber's new voicemail account on the destination voicemail system (e.g., VMS A 610). Similarly, at operation 654, the voicemail migration server 606 may transmit the recorded name to the gateway A 608, which in turn will deposit the recorded name into the subscriber's new voicemail account on the VMS A 610. The voicemail migration server 606 may also transmit the one or more voicemail messages from the old voicemail account to the gateway A 608 at operation 656, which in turn will deposit the voicemail messages into the subscriber's new voicemail account on the VMS A 610. In some cases, before the recorded audio information is deposited into the new voicemail account, the gateway A 608 may encode the recorded audio with a codec in order to prevent unauthorized access.

The profile information may also be transmitted to the gateway A 608 at operation 658 and the gateway A 608 can deposit the profile information into the new voicemail account on the VMS A 610. When all of the information from the old voicemail account has been deposited into the subscriber's new voicemail account, the VMS A 610 may transmit a deposit status to the gateway A 608 at operation 660. The gateway A 608 may then transmit the status of the depositing back to the voice migration server 606. If the status indicates that the depositing of the voicemail information from the old voicemail account into the subscriber's new voicemail account was successful, at operation 662, the voicemail migration server 606 may transmit a communication to the TSAS 604 indicating that the old voicemail account may be deleted. In response to receiving the communication, the TSAS 604 may transmit a communication to the source voicemail system instructing the source voicemail system to delete the subscriber's old voicemail account.

Although in FIG. 6A and FIG. 6B, the retrieval of the voicemail information from the source voicemail system is finished before and the transmission of the voicemail information to the destination voicemail system begins, in other aspects, the pieces of the voicemail information may be transmitted to the destination voicemail system as it is received. Furthermore, different portions of the voicemail information may be retrieved or transmitted in different orders than the order shown in FIG. 6A and FIG. 6B.

FIG. 7 is a flow diagram illustrating another example of a process for migrating a subscriber's voicemail information from a source voicemail system to a destination voicemail system. In the example illustrated in FIG. 7, the subscriber's voicemail information is transferred from an existing voicemail account on VMS A 710 to a new voicemail account on VMS B 714.

At operation 720, the migration initiator 702 may transmit instructions to the TSAS 704 to initiate a voicemail account migration in response to, for example, a subscriber getting a new phone supported by a different voicemail system or moving to a new geographic area supported by a different voicemail system. The instructions may be in the form of a special feature offering (SFO) code. When the TSAS 704 receives the SFO code, the TSAS 704 may look up the SFO code in a SFO code table and determine that the subscriber's voicemail account on a source voicemail system (e.g., VMS A 710) is to be migrated to another voicemail account on a destination voicemail system (e.g., VMS B 714).

In response to receiving instructions to initiate the voicemail account migration, at operation 722, the TSAS 704 sends instructions to the destination voicemail system to create the new voicemail account for the subscriber. The destination voicemail system (VMS) B 714 can create the new voicemail account for the subscriber in response to receiving the instructions. At operation 724, the TSAS 704 may transmit to the VMS B 714 information needed to set up the newly created voicemail account. The information may include an indication of features, characteristics for the newly created account, and/or instructions to create an inbox for the new voicemail account.

At operation 726, the TSAS 704 sends instructions to the voicemail migration server 706 to migrate information in the subscriber's old voicemail account on the source voicemail system to the new voicemail account on the destination voicemail system (e.g., VMS B 714). The instructions to migrate the voicemail information may identify the source voicemail system (e.g., VMS A 710) that the old voicemail account is on and/or the voicemail gateway (e.g., gateway A 708) supporting the source voicemail system. At operation 728, the VM migration server 706 may transmit a request for voicemail information stored in the old voicemail account at operation 728.

As discussed above, some of the voicemail information stored by the source voicemail system (e.g., VMSA 710) may be encrypted. For example, recorded audio such as voicemail messages, the recorded name, or the voicemail greeting may be encrypted. However, other voicemail information may also be encrypted. As such, operation 728 shows the voicemail migration server 706 transmitting the request for voicemail information to gateway A 708, which relays the request to the source voicemail system VMS A 710. In response to receiving the request, VMS A 710 may retrieve the voicemail information stored in the subscriber's old voicemail account and transmit the voicemail information to gateway A 708 at operation 730. Gateway A 708 may then decode any encrypted voicemail information and transmit the decoded voicemail information back to the VM migration server 706.

According to some variations, the voicemail migration server 706 may not be aware of which voicemail system the subscriber's new voicemail account is located on based on the instructions received from the TSAS 704 to migrate the subscriber's voicemail information. Accordingly, in response to receiving the migration instructions, the voicemail migration server 706 may probe the voicemail gateway (e.g., gateway B 712) for information needed to access the destination voicemail system at operation 732. For example, the probe may be a communication sent to gateway B 712 requesting the location (e.g., the internet protocol (IP) address) for the destination voicemail system (e.g., VMS B 714) that the subscriber's new voicemail account is located on.

The voicemail gateway B 712 may determine the location of the destination voicemail system that the subscriber's new account is on (e.g., VMS B 714) and return the location (e.g., the IP address) to the voicemail migration server 706 at operation 734. At operation 736, the voicemail migration server 706 may contact the destination voicemail system (e.g., VMS B 714) to establish a migration channel between the VM migration server 706 and VMS B 714. According to some implementations, establishing a migration channel may involve sending a communication to the VMS B 714 that sets the voicemail system's access level to one that allows for access to store information in the new voicemail account.

According to some implementations, after the migration channel is established, the voicemail migration server 706 may request a password for the subscriber's new voicemail account from VMS B 714 at operation 738 and at operation 740, VMS B 714 may respond by transmitting the requested password to the voicemail migration server 706. The password may be retrieved so that the voicemail migration server 706 may set the password for the new voicemail account to be the same as the password for the existing voicemail account. Accordingly, the subscriber may be able to use the password for the old voicemail account to access the new voicemail account instead of needing to set a new password for the new voicemail account.

At operation 742, the voicemail migration server 706 may transmit profile information retrieved from the subscriber's voicemail account to the destination voicemail system, VMS B 714, where the profile information may be stored in the subscriber's new voicemail account. As described above, the profile information may include voicemail settings, preferences, subscriber information, or subscriber passwords used to access the voicemail account. In some cases, the destination VMS B 714 stores the recorded audio (e.g., the voicemail greeting, the recorded name, the voicemail messages, etc.) for the subscriber's voicemail account in an encoded form to prevent unauthorized access to the recorded audio. Accordingly, gateway B 712 may be used as an intermediary between VMS B 714 and the voicemail migration server 706 and encodes the recorded audio before transmitting the recorded audio to VMS B 714. For example, at operation 744, the voicemail migration server 706 may transmit the unencoded recorded audio for the subscriber's new voicemail account to gateway B 712 where the recorded audio can be encoded before being retransmitted to VMS B 714 for depositing into the subscriber's new voicemail account.

When all of the information from the old voicemail account has been deposited into the subscriber's new voicemail account, VMS B 714 may transmit a deposit status to the gateway B 712 at operation 746. Gateway B 712 may then transmit the status of the depositing back to the voice migration server 706. If the status indicates that the depositing of the voicemail information from the old voicemail account into the subscriber's new voicemail account was successful, at operation 748, the voicemail migration server 706 may transmit a communication to VMS B 714 to close the migration channel. The voicemail migration server 706 may also transmit a communication to the TSAS 704 indicating that the old voicemail account may be deleted at operation 750. In response to receiving the communication, the TSAS 704 may transmit a communication to the source voicemail system instructing the source voicemail system to delete the subscriber's old voicemail account.

In some cases, a subscriber may move combine voicemail accounts on a voicemail system or move from an old voicemail account on the voicemail system to a new voicemail account on the same voicemail system. For example, FIG. 8 is a flow diagram illustrating an example of a process for migrating a subscriber's voicemail information to a new voicemail account on a voicemail system. At operation 820, the migration initiator 802 may transmit instructions to the TSAS 804 to initiate a voicemail account migration from one voicemail account on VMS A 810 to another voicemail account on VMS A 810.

In response to receiving instructions to initiate the voicemail account migration, at operation 822, the TSAS 804 sends instructions to VMS A 810 to create the new voicemail account for the subscriber and VMS A 810 can create the new voicemail account for the subscriber in response to receiving the instructions. At operation 824, the TSAS 804 may transmit to VMS A 810 information needed to set up the newly created voicemail account. The information may include an indication of features, characteristics for the newly created account, and/or instructions to create an inbox for the new voicemail account. At operation 726, the TSAS 704 sends instructions to VMS A 810 to move information in the subscriber's old voicemail account on the source voicemail system to the new voicemail account. At operation 728, in response to receiving the move instructions, VMS A 810, may move voicemail information from the subscriber's old voicemail account to the new voicemail account.

In FIG. 8, the VMS A 810 may be configured to migrate voicemail information from one account on the system to another. Since the old voicemail account and the new voicemail account are on the same voicemail system (e.g., VMS A 810), there is no need to decode or encode voicemail information before it is moved to the new voicemail account. Furthermore, there is also no need for a voicemail migration server to act as an intermediary to migrate the information from the old voicemail account to the new voicemail account. However, in some cases, the voicemail system is not configured to migrate voicemail information from one account to another without additional help. For example, FIGS. 9A and 9B are flow diagrams illustrating another example of a process for migrating a subscriber's voicemail information to a new voicemail account on a voicemail system.

The migration initiator 902 may transmit instructions, at operation 920, to the TSAS 904 to initiate a voicemail account migration from an old voicemail account on VMS B 914 to a new voicemail account also on VMS B 914. When the TSAS 904 receives instructions to initiate the voicemail account migration, at operation 922, the TSAS 904 sends instructions to the VMS B 914 to create the new voicemail account for the subscriber. In response to receiving the instructions, VMS B 914 can create the new voicemail account for the subscriber. At operation 924, the TSAS 904 may transmit instructions to the voicemail migration server 906 to migrate information in the subscriber's old voicemail account on VMS B 914 to the new voicemail account also on VMS B 914.

In some cases, the voicemail migration server 906 may not be aware of on which voicemail system the subscriber's existing voicemail account is located. Accordingly, in response to receiving the migration instructions, the voicemail migration server 906 may probe the voicemail gateway (e.g., gateway B 912) for the source voicemail system (e.g., VMS B 914) for information needed to access the source voicemail system at operation 926. For example, the probe may be a communication sent to gateway B 912 requesting the location (e.g., IP address) for VMS B 914. The voicemail gateway B 912 may determine the location of VMS B 914 and return the location (e.g., the IP address) to the voicemail migration server 906 at operation 928.

At operation 930, the voicemail migration server 906 may contact VMS B 914 using the location information received from voicemail gateway B 912 to establish a migration channel between the VM migration server 906 and the VMS B 914. After the migration channel is established, the voicemail migration server 906 may request the information in the subscriber's existing voicemail account using one or more requests. For example, at operation 932, the voicemail migration server 906 may transmit a request for voicemail account profile information to VMS B 914. The profile information may include voicemail settings, preferences, subscriber information, or other unencoded information stored in the voicemail account. In response to receiving the request for profile information, VMS B 914 may retrieve the profile information and transmit the profile information to the voicemail migration server 906 at operation 934.

As discussed above, the recorded audio (e.g., the voicemail greeting, the recorded name, the voicemail messages, etc.) in the subscriber's old voicemail account may be stored in VMS B 914 in an encoded form to prevent unauthorized access to the recorded audio. Accordingly, gateway B 912 may be used to decode the recorded audio before the recorded audio is received by the voicemail migration server 906. For example, at operation 936, the voicemail migration server 906 may transmit a request for a voicemail greeting to the gateway B 912 and the gateway B 912 can relay the request to the VMS B 914. In response to receiving the request, the VMS B 914 may retrieve the encoded voicemail greeting in the subscriber's voicemail account and transmit it to the gateway B 912. Similarly, at operation 938, the voicemail migration server 906 may transmit a request for a recorded name to the gateway B 912 and the gateway B 912 can relay the request to the VMS B 914. In response to receiving the request, the VMS B 914 may retrieve the encoded recorded name in the subscriber's voicemail account and transmit it to the gateway B 912. At operation 940, the voicemail migration server 906 may also transmit a request for one or more of the voicemail messages in the subscriber's voicemail account to the gateway B 912 and the gateway B 912 can relay the request to the VMS B 914. In response to receiving the request, the VMS B 914 may retrieve the encoded voicemail messages in the subscriber's voicemail account and transmit it to the gateway B 912. At the gateway B 912, the encoded voicemail greeting, the encoded recorded name, the encoded voicemail messages, or other recorded audio in the subscriber's voicemail account may be decoded and, at operation 942, the decoded recorded audio can be transmitted to the voicemail migration server 906.

Once voicemail information from the subscriber's voicemail account on the source voicemail system is received, the voicemail migration server 906 may begin transmitting the voicemail information for depositing into the subscriber's new voicemail account on VMS B 914. For example, at operation 952 in FIG. 9B, the voicemail migration server 906 may request a password for the subscriber's new voicemail account from VMS B 914 and at operation 954, VMS B 714 may respond by transmitting the requested password to the voicemail migration server 706.

At operation 956, the voicemail migration server 906 may transmit the voicemail greeting to gateway B 912, which in turn will deposit the voicemail greeting into the subscriber's new voicemail account on the destination voicemail system (e.g., VMS B 914). Similarly, at operation 958, the voicemail migration server 906 may transmit the recorded name to gateway B 912, which in turn will deposit the recorded name into the subscriber's new voicemail account on VMS B 914. The voicemail migration server 906 may also transmit the one or more voicemail messages from the old voicemail account to gateway B 912 at operation 960, which in turn will deposit the voicemail messages into the subscriber's new voicemail account on VMS B 914. In some cases, before the recorded audio information is deposited into the new voicemail account, gateway B 912 may encode the recorded audio with a codec in order to prevent unauthorized access.

At operation 962, the profile information may also be transmitted to gateway B 912 and gateway B 912 can deposit the profile information into the new voicemail account on the VMS B 914. When all of the information from the old voicemail account has been deposited into the subscriber's new voicemail account, VMS B 914 may transmit a deposit status to gateway B 912 at operation 964. Gateway B 912 may then transmit the status of the depositing back to the voice migration server 906. If the status indicates that the depositing of the voicemail information from the old voicemail account into the subscriber's new voicemail account was successful, at operation 966, the voicemail migration server 906 may send a communication closing the migration channel to VMS B 914. The voicemail migration server 906 may also transmit a communication to the TSAS 904 indicating that the old voicemail account may be deleted at operation 968. In response to receiving the communication, at operation 970, the TSAS 904 may transmit a communication to VMS B 914 instructing VMS B 914 to delete the subscriber's old voicemail account.

FIGS. 10 and 11 provide functional block diagram illustrations of general purpose computer hardware platforms. FIG. 10 illustrates a network or host computer platform, as may typically be used to implement a server. For example, the computer platform illustrated in FIG. 10 may be used to implement the TSAS server 210, the VM migration server 220, the vendor gateways 222 and 224, and/or the VM systems 212, 214, 216 of FIG. 2. FIG. 11 depicts a computer with user interface elements, as may be used to implement a personal computer or other type of work station or terminal device, although the computer of FIG. 11 may also act as a server if appropriately programmed. For example, the computer platform illustrated in FIG. 11 may be used to implement the migration initiator 702 in FIG. 7. It is believed that the general structure and general operation of such equipment as shown in FIGS. 10 and 11 should be self-explanatory from the high-level illustrations.

A server, for example, includes a data communication interface for packet data communication. The server also includes a central processing unit (CPU), in the form of one or more processors, for executing program instructions. The server platform typically includes an internal communication bus, program storage and data storage for various data files to be processed and/or communicated by the server, although the server often receives programming and data via network communications. The hardware elements, operating systems and programming languages of such servers are conventional in nature. Of course, the server functions may be implemented in a distributed fashion on a number of similar platforms, to distribute the processing load.

A computer type user terminal device, such as a PC or tablet computer, similarly includes a data communication interface CPU, main memory and one or more mass storage devices for storing user data and the various executable programs (see FIG. 11). A mobile device type user terminal may include similar elements, but will typically use smaller components that also require less power, to facilitate implementation in a portable form factor. The various types of user terminal devices will also include various user input and output elements. A computer, for example, may include a keyboard and a cursor control/selection device such as a mouse, trackball, joystick or touchpad; and a display for visual outputs. A microphone and speaker enable audio input and output. Some smartphones include similar but smaller input and output elements. Tablets and other types of smartphones utilize touch sensitive display screens, instead of separate keyboard and cursor control elements. The hardware elements, operating systems and programming languages of such user terminal devices also are conventional in nature.

Hence, aspects of the methods of migrating a subscriber's voicemail information from one voicemail account to another outlined above may be embodied in programming. Program aspects of the technology may be thought of as “products” or “articles of manufacture” typically in the form of executable code and/or associated data that is carried on or embodied in a type of machine readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the service provider into the computing device that will be the telephone service activation system (TSAS) server or the voicemail migration server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like. Volatile storage media include dynamic memory, such as main memory of such a computer platform. Tangible transmission media include coaxial cables; copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A system comprising:
a computer configured as a telephone service activation system to:
a) determine, responsive to a received instruction, to migrate a subscriber's existing voicemail account from a source voicemail system to a new voicemail account on a destination voicemail system;
b) send an instruction to a computer of the destination voicemail system to create the new voicemail account for the subscriber; and
c) send a migration instruction to a migration server; and
a computer configured as the migration server to:
i) responsive to the migration instruction, obtain, from a computer of the source voicemail system, profile information for a profile of the subscriber's existing voicemail account and one or more voicemail messages stored on the computer of the source voicemail system for the subscriber's existing voicemail account;
ii) transmit the obtained profile information to the computer of the destination voicemail system, for configuration of the new voicemail account for the subscriber at least in part in accordance with the profile of the subscriber's existing voicemail account; and
iii) transmit the obtained one or more voicemail messages for storage on the computer of the destination voicemail system in association with the new voicemail account for the subscriber on the destination voicemail system.

2. The system of claim 1, further comprising:
a gateway computer for the computer of the source voicemail system, wherein:
the computer configured as the migration server is further configured to obtain, from the computer of the source voicemail system, at least a portion of the profile information and the one or more voicemail messages by transmitting a request for the portion of the profile information and the one or more voicemail messages to the gateway computer for the computer of the source voicemail system, and
the gateway computer for the computer of the source voicemail system is configured to retrieve the portion of the profile information and the one or more voicemail messages from the computer of the source voicemail system and transmit the portion of the profile information and the one or more voicemail messages to the computer configured as the migration server.

3. The system of claim 2, wherein:
the portion of the profile information and the one or more voicemail messages stored on the computer of the source voicemail system for the subscriber's existing voicemail account are encoded, and
the gateway computer for the computer of the source voicemail system is further configured to decode the portion of the profile information and the one or more voicemail messages before transmitting the portion of the profile information and the one or more voicemail messages to the computer configured as the migration server.

4. The system of claim 1, further comprising:
a gateway computer for the computer for the destination voicemail system, wherein:
the computer configured as the migration server is further configured to transmit the obtained one or more voicemail messages for storage on the computer of the destination voicemail system by transmitting the obtained one or more voicemail messages to the gateway computer for the computer of the destination voicemail system, and the gateway computer for the computer of the destination voicemail system is configured to redirect the obtained one or more voicemail messages to the computer of the destination voicemail system.

5. The system of claim 4, wherein the gateway computer for the computer of the destination voicemail system is further configured to encode the obtained one or more voicemail messages before redirecting the obtained one or more voicemail messages to the computer of the destination voicemail system.

6. The system of claim 1, wherein the computer configured as the migration server is further configured to obtain from the computer of the source voicemail system profile information for the profile of the subscriber's existing voicemail account comprising at least one of voicemail account settings, preferences, subscriber information, subscriber passwords used to access the existing voicemail account, or recorded audio for the existing voicemail account.

7. The system of claim 6, wherein the computer configured as the migration server is further configured to obtain from the computer of the source voicemail system the recorded audio for the existing voicemail account comprising at least one of a recorded greeting or a recorded subscriber name.

8. The system of claim 1, wherein the computer configured as the telephone service activation system is further configured to receive the received instruction sent by a migration initiator in response to at least one of the subscriber changing mobile devices, the subscriber moving to a different geographic location, or the subscriber changing mobile device numbers.

9. The system of claim 1, wherein computer configured as the telephone service activation system is further configured to determine to migrate the subscriber's existing voicemail account from the source voicemail system to the new voicemail account on the destination voicemail system wherein the source voicemail system is the same voicemail system as the destination voicemail system.

10. The system of claim 1, wherein:
the computer configured as the migration server is further configured to send a communication to the computer configured as the telephone service activation system indicating that the subscriber's existing voicemail account from the source voicemail system can be deleted; and
the computer configured as the telephone service activation system is further configured to send an instruction to the computer of the source voicemail system to delete the subscriber's existing voicemail account in response to receiving the communication indicating that the subscriber's existing voicemail account from the source voicemail system can be deleted.

11. A method comprising steps of:
determining to migrate a subscriber's existing voicemail account from a source voicemail system to a new voicemail account on a destination voicemail system;
sending an instruction to a computer of the destination voicemail system to create the new voicemail account for the subscriber;
obtaining from a computer of the source voicemail system profile information for a profile of the subscriber's existing voicemail account and one or more voicemail messages stored on the computer of the source voicemail system for the subscriber's existing voicemail account;
transmitting the obtained profile information to the computer of the destination voicemail system, for configuration of the new voicemail account for the subscriber at least in part in accordance with the profile of the subscriber's existing voicemail account; and
transmitting the obtained one or more voicemail messages for storage on the computer of the destination voicemail system in association with the new voicemail account for the subscriber on the destination voicemail system.

12. The method of claim 11, wherein obtaining, from the computer of the source voicemail system, the profile information and the one or more voicemail messages comprises:
transmitting one or more requests for at least a portion of the profile information and the one or more voicemail messages to a gateway computer for the computer of the source voicemail system, and
receiving the portion of the profile information and the one or more voicemail messages from the gateway computer for the computer of the source voicemail system.

13. The method of claim 12, wherein receiving the portion of the profile information and the one or more voicemail messages comprises receiving the portion of the profile information that has been decoded by the gateway computer and receiving one or more voicemail messages that have been decoded by the gateway computer.

14. The method of claim 11, wherein transmitting the obtained profile information to the computer of the destination voicemail system, comprises transmitting at least a portion of the obtained profile information to a gateway computer for the computer of the destination voicemail system, wherein the gateway computer is configured to redirect the portion of the obtained profile information to the computer of the destination voicemail system.

15. The method of claim 11, wherein transmitting the obtained one or more voicemail messages for storage on the computer of the destination voicemail system comprises transmitting the obtained one or more voicemail messages to a gateway computer for the computer of the destination voicemail system, wherein the gateway computer is configured to redirect the obtained one or more voicemail messages to the computer of the destination voicemail system.

16. The method of claim 15, wherein the source voicemail system is the same voicemail system as the destination voicemail system.

17. The method of claim 11, further comprising sending an instruction to the computer of the source voicemail system to delete the subscriber's existing voicemail account in response to an indication that the subscriber's existing voicemail account has been successfully migrated.

18. A non-transitory machine-readable medium comprising instructions stored therein, which when executed by a processor, cause the processor to perform operations comprising operations to:
determine to migrate a subscriber's existing voicemail account from a source voicemail system to a new voicemail account on a destination voicemail system;
send an instruction to a computer of the destination voicemail system to create the new voicemail account for the subscriber;
obtain from a computer of the source voicemail system profile information for the subscriber's existing voicemail account and one or more voicemail messages stored on the computer of the source voicemail system for the subscriber's existing voicemail account;
transmit the obtained profile information to the computer of the destination voicemail system, for configuration of the new voicemail account for the subscriber at least in part in accordance with a profile of the existing voicemail account; and
transmit the obtained one or more voicemail messages for storage on the computer of the destination voicemail system in association with the new voicemail account for the subscriber on the destination voicemail system.

19. The non-transitory machine-readable medium of claim 18, wherein the operations to obtain from the computer of the source voicemail system profile information for the profile of the subscriber's existing voicemail account comprise operations to obtain at least one of voicemail account settings, preferences, subscriber information, subscriber passwords used to access the existing voicemail account, and recorded audio for the existing voicemail account.

20. The non-transitory machine-readable medium of claim 18, further comprising instructions stored therein, which when executed by the processor, cause the processor to perform operations comprising operations to send an instruction to the computer of the source voicemail system to delete the subscriber's existing voicemail account.
